(19) United States
(12) Patent Application Publication
(10) Pub. No.: US 2004/0230800 A1
(43) Pub. Date: Nov. 18, 2004

(54) Apparatus authentication system, server apparatus, and client apparatus

(76) Inventors: Yuichi Futa, Osaka (JP); Natsume Matsuzaki, Osaka (JP); Hiroki Yamauchi, Osaka (JP); Yuusaku Ohta, Kyoto (JP); Naoshi Usuki, Kyoto (JP); Yasushi Ayaki, Osaka (JP); Yoshihiro Morioka, Nara (JP)

Correspondence Address: WENDEROTH, LIND & PONACK, L.L.P., 2033 K STREET N. W., SUITE 800, WASHINGTON, DC, 20006-1021, US

(21) Appl. No.: 10/822,778

(22) Filed: Apr. 13, 2004

(30) Foreign Application Priority Data
Apr. 14, 2003 (JP) 2003-109264

(51) Int. Cl. H04L 9/00

(52) U.S. Cl. 713/169

(57) ABSTRACT

An apparatus authentication system that includes a server apparatus and a client apparatus which perform a mutual authentication when a content is transmitted from the server apparatus to the client apparatus for use. The client apparatus receives challenge data from the server apparatus, generates signature data based on the received challenge data and a first password, and transmits the generated signature data. The server apparatus generates and transmits the challenge data, holds a second password in advance, receives the signature data from the client apparatus, performs an authentication of the received signature data using the challenge data and the second password, and if the authentication results in success, transmits an encrypted content to the client apparatus.

### BACKGROUND OF THE INVENTION

(1) Field of the Invention

The present invention relates to an apparatus authentication system in which a mutual authentication is performed between apparatuses when a digital content is transferred between them.

(2) Description of the Related Art

In recent years, the easy acquisition of digital copyrighted works (hereinafter “contents”), such as music, videos, games and so forth, has become possible as a result of circulation using the Internet, digital broadcast, package media and the like.

To avoid unauthorized use of the circulated contents and allow only authorized apparatuses to use the contents, the contents are encrypted before the distribution.

Document 1 (identification provided at the last portion of this section) discloses a specification called Digital Transmission Content Protection (DTCP).

DTCP is a protection specification for digital contents delivered via a bus standardized by IEEE 1394, which is a high-speed serial bus standard. Each apparatus that uses contents has a secret key and a certificate distributed by a manager known as the Digital Transmission Licensing Administrator (DTLA).

When contents are to be distributed, mutual authentication is conducted between a transmitting apparatus and a receiving apparatus using the respective secret key and the certificate, and if authentication is successful, both apparatuses have a shared key. The transmitting apparatus encrypts the contents using the shared key, and transmits the encrypted contents to the receiving apparatus. The receiving apparatus decrypts the received contents for use.

There is a fear however that the above-described DTCP technology, which physically limits the use of contents based on the IEEE 1394 bus standard, might be misused in radio communications. For example, a third-party apparatus unauthorized to obtain a certain content may obtain the content by connecting via radio communications to an apparatus authorized to distribute the content, which is possible in so far as the third-party apparatus has the secret key and the certificate which are issued from the DTLA if certain conditions are met. This will make, for example, a content distribution system vulnerable to various attacks such as a tapping and a disguise.

Document 2 (identification provided at the last portion of this section) discloses an encryption technology for radio communications. The technology is called WEP (Wired Equivalent Privacy) and is defined in IEEE802.11b.

In WEP, the user sets a password in an access point in advance. The password is used for an authentication that is performed to establish a communication, and is used for encryption of a content before it is transmitted. With this technology, unauthorized users, who are not given the password, cannot access the authorized apparatuses.

In WEP, however, users can determine whether to encrypt the contents or not. This renders the WEP technology insufficient to protect the contents to reliable levels.

Document 1: “5C Digital Transmission Content Protection White Paper (Revision 1.0)”, Jul. 14, 1998

Document 2: IEEE Std 802.11-1997, “Wireless LAN Medium Access Control (MAC) and Physical Layer (PHY) specifications”, pp. 62-66, 1997

### SUMMARY OF THE INVENTION

It is therefore the object of the present invention to provide an apparatus authentication system in which digital copyrighted works (contents) are protected from unauthorized accesses, and only apparatuses authenticated as having the right to use the contents are allowed to access the contents.

The object is fulfilled by an apparatus authentication system which comprises a server apparatus and a client apparatus which perform a mutual authentication when a content is transmitted from the server apparatus to the client apparatus for use therein, wherein the client apparatus includes: a receiving unit operable to receive challenge data from the server apparatus; a signature generating unit operable to generate signature data based on the received challenge data and a first password; and a transmitting unit operable to transmit the generated signature data, and the server apparatus includes: a challenge data transmitting unit operable to generate and transmit the challenge data; a holding unit operable to hold a second password in advance; a receiving unit operable to receive the signature data from the client apparatus; an authentication unit operable to perform an authentication of the received signature data based on the challenge data and the second password; and a content transmitting unit operable to, if the authentication results in success, transmit an encrypted content to the client apparatus, the encrypted content having been encrypted in such a manner that the encrypted content can be decrypted by the client apparatus.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the construction of the apparatus authentication system 1;

FIG. 2 is a block diagram showing the construction of the server apparatus 100 and the client apparatus 200;

FIG. 3 shows the data structure of the password correspondence table stored in the server apparatus 100;

FIG. 4 is a flowchart showing the procedure of the direct registration of passwords with the server apparatus 100 for the client apparatus 200;

FIG. 5 is a flowchart that is continued to FIG. 6 and shows the procedure of the remote registration of passwords with the server apparatus 100 performed at the client apparatus 200;

FIG. 6 is a continuation of the flowchart shown in FIG. 5 and shows the procedure of the remote registration of passwords with the server apparatus 100 performed at the client apparatus 200;

FIG. 7 is a flowchart that is continued to FIG. 8 and shows the procedure of distributing a content from the server apparatus 100 to the client apparatus 200; and

FIG. 8 is a continuation of the flowchart shown in FIG. 7 and shows the procedure of distributing a content from the server apparatus 100 to the client apparatus 200.

### DESCRIPTION OF THE PREFERRED EMBODIMENT

The following describes an embodiment of the present invention with reference to the attached drawings.

1. Construction of Apparatus Authentication System 1

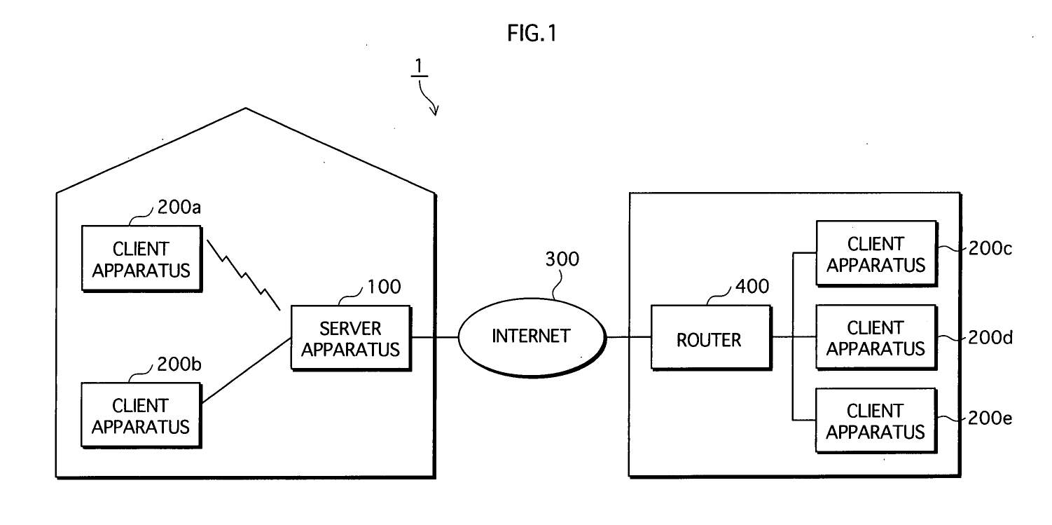

As shown in FIG. 1, an apparatus authentication system 1 includes a server apparatus 100, a plurality of client apparatuses 200a, . . . 200e, the Internet 300, and a router 400.

The server apparatus 100 stores contents of movies, music and the like, and distributes the contents to, among the client apparatuses 200a to 200e, client apparatuses for each of which an ID and passwords have been registered with the server apparatus 100. Passwords can be registered with the server apparatus 100 by a direct or remote registration. With the direct registration, a password to be registered is input directly into the server apparatus 100. With the remote registration, passwords to be registered are input into a client apparatus 200, then sent from it to the server apparatus 100.

Each client apparatus can perform radio and/or wired communications with the server apparatus 100, as indicated in FIG. 1 by the client apparatuses 200a and 200b, respectively. Also, each client apparatus can connect to the server apparatus 100 via the Internet 300, as indicated in FIG. 1 by the client apparatuses 200c to 200d. It should be noted here that although not illustrated, the apparatus authentication system 1 includes a plurality of routers in addition to the router 400.

It should be noted here that in the present document, the client apparatuses 200a to 200e may be referred to as a client apparatus 200 generically.

The following describes the construction of each component.

1.1 Server Apparatus 100

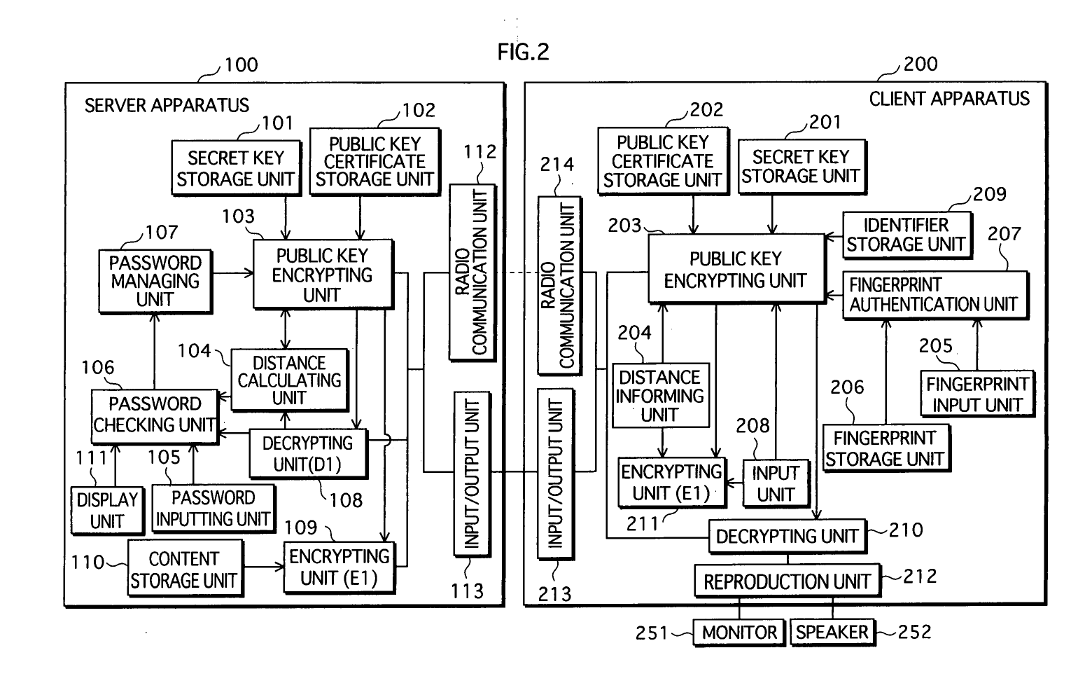

FIG. 2 shows the construction of the server apparatus 100 and the client apparatus 200. In FIG. 2, the router 400 and the Internet 300 are omitted for the sake of convenience.

The server apparatus 100, as shown in FIG. 2, includes a secret key storage unit 101, a public key certificate storage unit 102, a public key encrypting unit 103, a distance calculating unit 104, a password inputting unit 105, a password checking unit 106, a password managing unit 107, a decrypting unit 108, an encrypting unit 109, a content storage unit 110, a display unit 111, a radio communication unit 112, and an input/output unit 113.

The server apparatus 100 is a computer system composed of a microprocessor, a ROM, a RAM, a hard disk unit, a display unit or the like. The RAM or the hard disk unit stores a computer program. The server apparatus 100 achieves the function thereof as the microprocessor operates under the control of the computer program.

The following describes the construction of the components of the server apparatus 100.

(1) Radio Communication Unit 112, Input/Output Unit 113

The radio communication unit 112 performs radio communications with the client apparatus 200.

The radio communication unit 112 performs radio communications, for example, at 2.4 GHz of frequency and at approximately 11 Mbps of maximum transmission speed, in compliance with IEEE802.11b.

The input/output unit 113 is connectable to the Internet 300 or the client apparatus 200, and transfers data to/from the client apparatus 200 directly or via the Internet 300.

(2) Distance Calculating Unit 104

The distance calculating unit 104 calculates a communication distance between the client apparatus 200 and the server apparatus 100 during a mutual authentication with the client apparatus 200 or during a remote registration of passwords performed at the client apparatus 200. The distance calculating unit 104 uses a TTL value as a means to calculate the communication distance, where TTL stands for Time To Live. The TTL value is set in a TTL field in the header information of the IP packet, and is decremented each time the IP packet passes through a router.

In the apparatus authentication system 1, the TTL value is set to a standard value “n” when a data packet is transmitted from any client apparatus 200 to the server apparatus 100. The distance calculating unit 104 holds the standard value n in advance, and calculates a difference between the standard value n and a TTL value received from the client apparatus 200. It is determined that the distance is “short”, which means that data is transferred directly without passing through a router, when the difference is “0”; and is determined that the distance is “long”, which means that data is transferred via one or more routers, when the difference is no less than “1”.

Suppose, for example, that the standard value n is set to “255”, then if the TTL value of a received packet is “255”, it is determined that the distance is “short”; and if the TTL value is “254” or less, it is determined that the distance is “long”.

The distance calculating unit 104 outputs the calculated difference value to the password checking unit 106 during the process of password registration, and to the public key encrypting unit 103 during the process of contents distribution.

(3) Public Key Certificate Storage Unit 102

The public key certificate storage unit 102 stores a public key certificate CertA. The public key certificate CertA certifies the authenticity of a public key PKA for the server apparatus 100. The public key certificate CertA includes signature data SigA and the public key PKA. The signature data SigA is generated by CA (Certification Authority) by executing a signature algorithm S1 onto the public key PKA for the server apparatus 100 using a secret key SKCA for the CA. The CA is a reliable third party which issues a public key certificate that certifies the authenticity of a public key for an apparatus belonging to the apparatus authentication system 1. The signature algorithm S1 is, for example, an ElGamal signature on a finite field. The ElGamal signature is known, and therefore its explanation is omitted here.

The public key certificate storage unit 102 holds a public key PKCA for the CA that corresponds to the secret key SKCA.

(4) Secret Key Storage unit 101

The secret key storage unit 101 is a tamper-resistant area for storing a secret key SKA that corresponds to the public key PKA.

(5) Public Key Encrypting Unit 103

The public key encrypting unit 103, after having received a request to register passwords from a client apparatus 200, conducts a mutual authentication with the client apparatus 200 based on a public key cryptosystem, and shares a key CK with the client apparatus 200. For the mutual authentication and key sharing, which are not explained in detail here because they are known, see as one example “Modern Cryptosystems”, Tatsuaki Okamoto and Hirosuke Yamamoto, Sangyo Tosho (publishing company), 1997.

The public key encrypting unit 103 outputs the shared key CK to the decrypting unit 108.

The public key encrypting unit 103 also conducts a mutual authentication with the client apparatus 200 when a content is planned to be transmitted to the client apparatus 200, so that the content is transmitted to the client apparatus 200 only when the authenticity of both has been certified through the mutual authentication. The mutual authentication will be described later. The public key encrypting unit 103 also receives the value of a difference between a TTL value and the standard value n from the distance calculating unit 104, and determines whether the distance of a client apparatus 200 is “short” or “long”. More specifically, as described earlier, the public key encrypting unit 103 determines that the distance is “short” if the difference value is “0”, and “long” if the difference value is no less than “1”. This will be described in detail later.

When the public key encrypting unit 103 conducts a mutual authentication with a client apparatus 200, the two parties share an authentication key AK. The public key encrypting unit 103 outputs the shared authentication key AK to the encrypting unit 109.

(6) Decrypting Unit 108

The decrypting unit 108 receives the shared key CK from the public key encrypting unit 103 during the process of the remote registration of passwords at a client apparatus 200. The decrypting unit 108 also receives encrypted passwords via the input/output unit 113. The decrypting unit 108 decrypts the received encrypted passwords by executing a decryption algorithm D1 onto the encrypted passwords using the shared key CK, and as a result of this, obtains passwords. The decrypting unit 108 transmits the obtained passwords to the password checking unit 106.

(7) Password Managing Unit 107

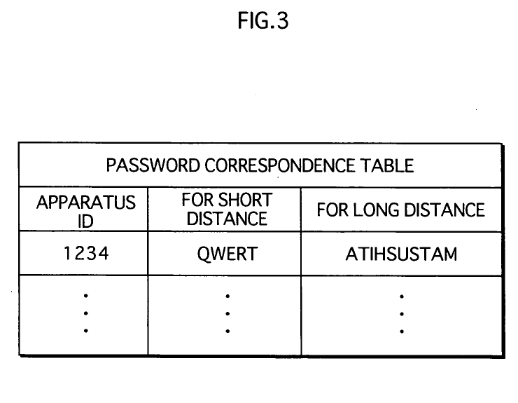

The password managing unit 107 has a storage area for storing a password correspondence table shown in FIG. 3. The storage area is structurally designed as tamper-resistant so that the table cannot be referred to from outside. The passwords can be stored and managed in the password correspondence table only if they pass the check by the password checking unit 106.

As shown in FIG. 3, the password correspondence table has three columns for each entry: “apparatus ID”, “for short distance”, and “for long distance”. With this construction, each entry has two types of passwords, a password for short distance and a password for long distance, for an ID of a client apparatus. The password for short distance is used for authentication when the server apparatus 100 communicates with a client apparatus directly. The password for long distance is used for authentication when the server apparatus 100 communicates with a client apparatus via the router. The passwords for short distance are shorter than the passwords for long distance. The passwords consist of alphabets. However, any word that is contained in a dictionary cannot be registered with the table.

(8) Password Inputting Unit 105

The password inputting unit 105 receives inputs from the user during the process of direct registration of passwords of the client apparatus 200. The password inputting unit 105 receives from the user two inputs for passwords for short and long distances, and outputs the received potential passwords to the password checking unit 106.

(9) Password Checking Unit 106, Display Unit 111

The display unit 111 display an image in accordance with an instruction from the password checking unit 106.

The password checking unit 106 checks the validity of the data input by the user as passwords to be registered with the password managing unit 107.

Each piece of input or received data is judged to be valid as a password if the data satisfies the following conditions for registration: (i) the data consists of a predetermined number of characters; (ii) the data does not contain any numeral or sign; and the data does not contain any word that is contained in a dictionary.

The password checking unit 106 stores, for use in checking the validity of data as passwords, (i) information indicating respective predetermined numbers of characters for short and long distances, (ii) a predetermined number of words that are contained in a dictionary, and (iii) the alphabets that can be used for the passwords.

In the direct registration, the password checking unit 106 checks the validity of two pieces of input data for passwords by judging whether they satisfy the above-mentioned conditions for passwords, and if having judged that the two pieces of input data are valid as passwords, outputs the two pieces of input data to the password managing unit 107 so that they are registered as passwords. If having judged that the two pieces of input data are invalid as passwords, the password checking unit 106 instructs the display unit 111 to display a reentrance screen that shows a message for the user that the input data is inappropriate and therefore the user is requested to input different sets of character sequences.

In the remote registration, the password checking unit 106 receives the value of a difference between a TTL value and the standard value n from the distance calculating unit 104, and determines that the server apparatus 100 is directly connected to the client apparatus 200 if the difference value is “0”, and determines that the server apparatus 100 is not directly connected to the client apparatus 200 if the difference value is no less than “1”. If having determined that the server apparatus 100 is not directly connected to the client apparatus 200, the password checking unit 106 transmits to the client apparatus 200 a notification that the remote registration is not available at the client apparatus 200, and ends the process. If having determined that the server apparatus 100 is directly connected to the client apparatus 200, the password checking unit 106 receives two plaintext passwords from the decrypting unit 108, and checks the validity of the plaintext passwords by judging whether they satisfy the conditions for the password registration. If it has judged that the plaintext passwords are valid as passwords, the password checking unit 106 outputs the passwords to the password managing unit 107 so that they are registered as passwords. The password checking unit 106 then transmits the client apparatus 200 a notification that the password registration has completed. If it has judged that the plaintext passwords are invalid as passwords, the password checking unit 106 transmits the client apparatus 200 a notification that the passwords are invalid, and waits for another set of passwords to be received.

(10) Content Storage Unit 110

The content storage unit 110 stores digital contents of movies, music and the like. It should be noted here that how such digital contents are acquired is not described in detail since it is irrelevant to the subject of the present invention. As one example, however, such digital contents can be acquired from a recording medium such as a DVD, via a network, or through broadcasting.

(11) Encrypting Unit 109

The encrypting unit 109 receives the authentication key AK from the public key encrypting unit 103 when a content is planned to be transmitted to the client apparatus 200. The encrypting unit 109 reads the content from the content storage unit 110, and encrypts the content by executing an encryption algorithm El onto the content using the received authentication key AK to generate an encrypted content. The encrypting unit 109 transmits the generated encrypted content to the client apparatus 200 via the input/output unit 113.

1.2 Client Apparatus 200

The client apparatus 200 includes a secret key storage unit 201, a public key certificate storage unit 202, a public key encrypting unit 203, a distance informing unit 204, a fingerprint input unit 205, a fingerprint storage unit 206, a fingerprint authentication unit 207, an input unit 208, an identifier storage unit 209, a decrypting unit 210, an encrypting unit 211, a reproduction unit 212, an input/output unit 213, and a radio communication unit 214. The reproduction unit 212 is connected with a monitor 251 and a speaker 252.

The client apparatus 200 is, as is the case with the server apparatus 100, a computer system composed of a microprocessor, a ROM, a RAM, a hard disk unit, a display unit or the like. The RAM or the hard disk unit stores a computer program. The client apparatus 200 achieves the function thereof as the microprocessor operates under the control of the computer program.

The following describes the construction of the components of the client apparatus 200.

(1) Radio Communication Unit 214, Input/Output Unit 213

The radio communication unit 214, as is the case with the radio communication unit 112, performs radio communications with the server apparatus 100 in compliance with IEEE802.11b.

The input/output unit 213 performs wired communications with other apparatuses. The input/output unit 213 is connectable to the server apparatus 100, for example, via buses conforming to IEEE1394. The input/output unit 213 is also connectable to the Internet 300 so that it can transfer data to/from the server apparatus 100 via the Internet 300 even if the client apparatus 200 is greatly distant from the server apparatus 100.

(2) Identifier Storage Unit 209

The identifier storage unit 209 stores an identifier IDb of the client apparatus 200.

(3) Input Unit 208

The input unit 208 receives a request to register passwords or a request to acquire a content which are input by the user, and outputs the received request to the public key encrypting unit 203.

When it receives a request to register passwords by a remote registration, the input unit 208 further receives, from the user, respective passwords for short and long distances, and outputs the received passwords to the encrypting unit 211.

When it receives a request to acquire a content, the input unit 208 outputs the request to the public key encrypting unit 203, further receives, from the user, a password for the short or long distance, and outputs the received password to the public key encrypting unit 203.

(4) Encrypting Unit 211

The encrypting unit 211 receives the shared key CK from the public key encrypting unit 203, and receives the passwords for short and long distances from the input unit 208. The encrypting unit 211 encrypts the received passwords by executing the encryption algorithm E1 onto the passwords using the received shared key CK to generate encrypted passwords. The encrypting unit 211 transmits the generated encrypted passwords to the server apparatus 100 via the input/output unit 213.

(5) Distance Informing Unit 204

The distance informing unit 204 holds the standard value n, and outputs the standard value n, as the TTL value of a packet: to the encrypting unit 211 when the encrypting unit 211 transmits the encrypted passwords to the server apparatus 100 during the process of a password registration; and to the public key encrypting unit 203 when the public key encrypting unit 203 performs a mutual authentication with the server apparatus 100 during the process of acquiring a content.

(6) Public Key Certificate Storage Unit 202

The public key certificate storage unit 202 stores a public key certificate CertB. The public key certificate CertB certifies the authenticity of a public key PKB for the client apparatus 200. The public key certificate CertB includes signature data SigB and the public key PKB. The signature data SigB is generated by CA (Certification Authority) by executing the signature algorithm Si onto the public key PKB for the client apparatus 200.

The public key certificate storage unit 202 holds a public key PKCA for the CA that corresponds to the secret key SKCA.

(7) Secret Key Storage Unit 201

The secret key storage unit 201 is tamper-resistant, and stores a secret key SKB that corresponds to the public key PKB.

(8) Public Key Encrypting Unit 203

The public key encrypting unit 203, during the process of registering passwords with the server apparatus 100, conducts a mutual authentication and shares the key CK with the server apparatus 100. The public key encrypting unit 203 outputs the shared key CK to the encrypting unit 211.

The public key encrypting unit 203 also conducts a mutual authentication with the server apparatus 100 when receiving a content from the server apparatus 100. During the mutual authentication, the public key encrypting unit 203 generates and outputs the authentication key AK to the decrypting unit 210.

(9) Fingerprint Input Unit 205

The fingerprint input unit 205 receives data of the user's fingerprint from outside, and outputs the received fingerprint data to the fingerprint authentication unit 207.

(10) Fingerprint Storage Unit 206

The fingerprint storage unit 206 stores, in advance, features of a fingerprint of an authorized user. Here, the fingerprint storage unit 206 may store features of a plurality of fingerprints.

(11) Fingerprint Authentication Unit 207

The fingerprint authentication unit 207 judges whether a user who input a fingerprint is the authorized user, based on the user's fingerprint received from the fingerprint input unit 205.

After receiving the fingerprint from the fingerprint input unit 205, the fingerprint authentication unit 207 extracts features of the fingerprint, reads the features of the authorized user's fingerprint from the fingerprint storage unit 206, and compares them to see how much they match, namely at what rate they match. The fingerprint authentication unit 207 judges that the person who input the fingerprint data is the authorized user if the rate of match exceeds a predetermined value. The person is permitted to use the client apparatus 200 if the fingerprint authentication unit 207 judges that the person is the authorized user. Otherwise, the person is prohibited from using the client apparatus 200.

(12) Decrypting Unit 210

The decrypting unit 210 receives the authentication key AK from the public key encrypting unit 203. The decrypting unit 210 decrypts an encrypted content received from the server apparatus 100 by executing the decryption algorithm D1 onto the encrypted content using the authentication key AK, and as a result of this, obtains a content. The process of the decryption algorithm D1 is a reverse of the process of the encryption algorithm E1, and returns the encrypted data to the original plain text. The decrypting unit 210 outputs the obtained content to the reproduction unit 212.

(13) Reproduction Unit 212

The reproduction unit 212 receives a content from the decrypting unit 210, generates a video signal from the received content, and outputs the video signal to the monitor 251. The reproduction unit 212 also generates an audio signal from the received content, and outputs the audio signal to the speaker 252.

2. Operation of Apparatus Authentication System 1

2.1 Password Registration

(1) Direct Registration at Server Apparatus 100

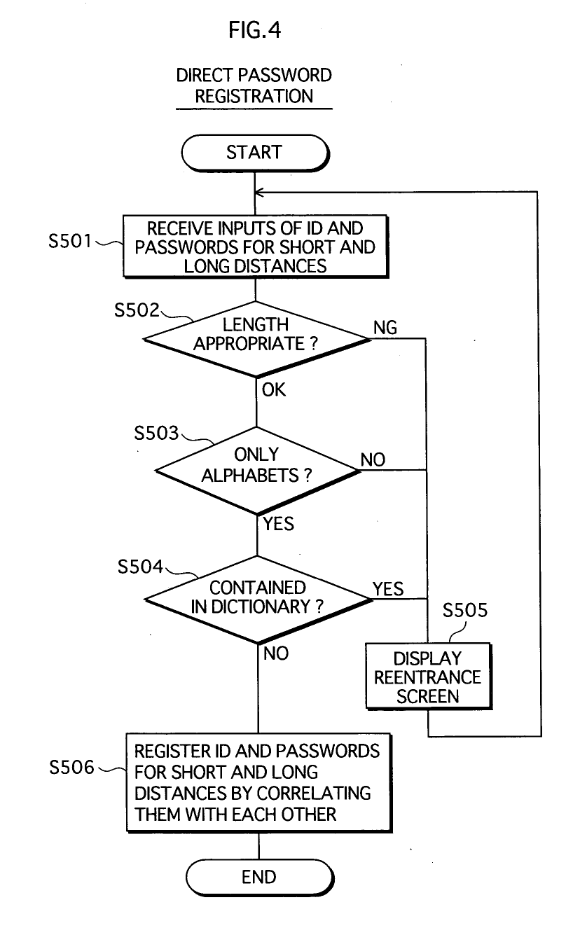

The direct registration of passwords with the server apparatus 100 for the client apparatus 200 will be described with reference to FIG. 4, a flowchart showing the procedures.

The password inputting unit 105 receives an input for an ID of the client apparatus 200 to be registered, and two inputs for passwords for short and long distances, and outputs the input data of the ID and passwords to the password checking unit 106 (step S501).

The password checking unit 106 checks the validity of each input password, by judging firstly whether its length is appropriate (step S502), secondly whether it consists of only alphabets (step S503), and thirdly whether it is a word that is contained in a dictionary (step S504). The password checking unit 106 judges that the input password is invalid as a password if it judges that the length of the input password is inappropriate (NG in step S502), that the input password includes any character other than alphabets (NO in step S503), or that the input password is a word that is contained in a dictionary (YES in step S504), then instructs the display unit 111 to display a reentrance screen, and returns to step S501.

The password checking unit 106 judges that the input password is valid as a password if it judges that the length of the input password is appropriate (OK in step S502), that the input password consists of only alphabets (YES in step S503), and that the input password is not a word that is contained in a dictionary (NO in step S504), then outputs the inputs of the ID and passwords to the password managing unit 107.

The password managing unit 107 registers the received input data with the password correspondence table, as an apparatus ID and two passwords correlated with each other in one entry (step S506), then ends the process.

(2) Remote Registration at Client Apparatus 200

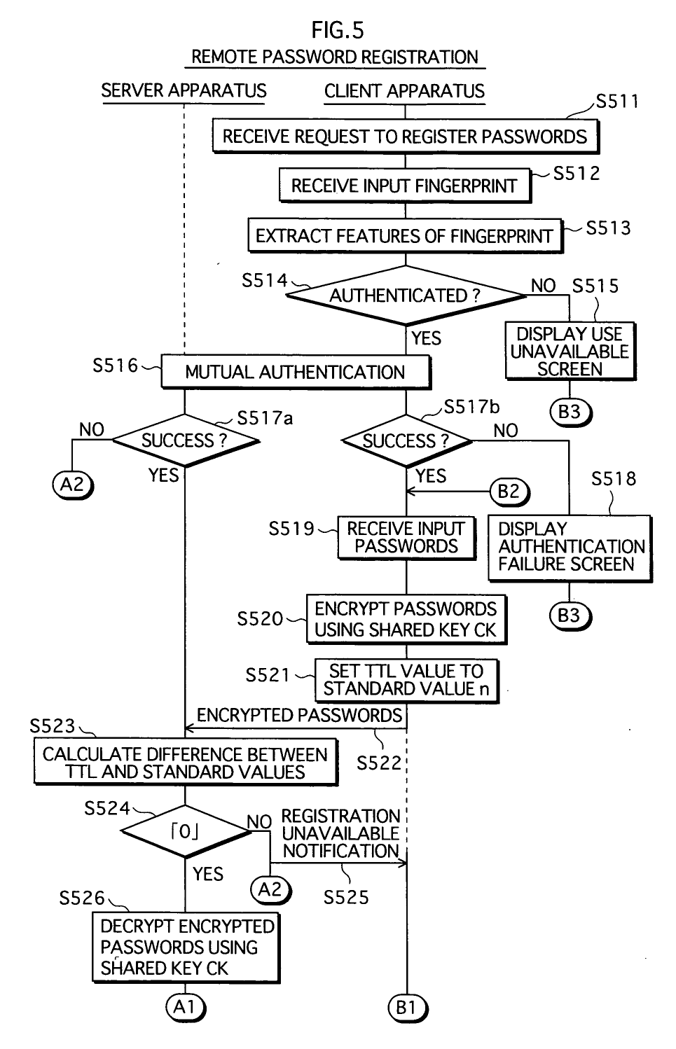

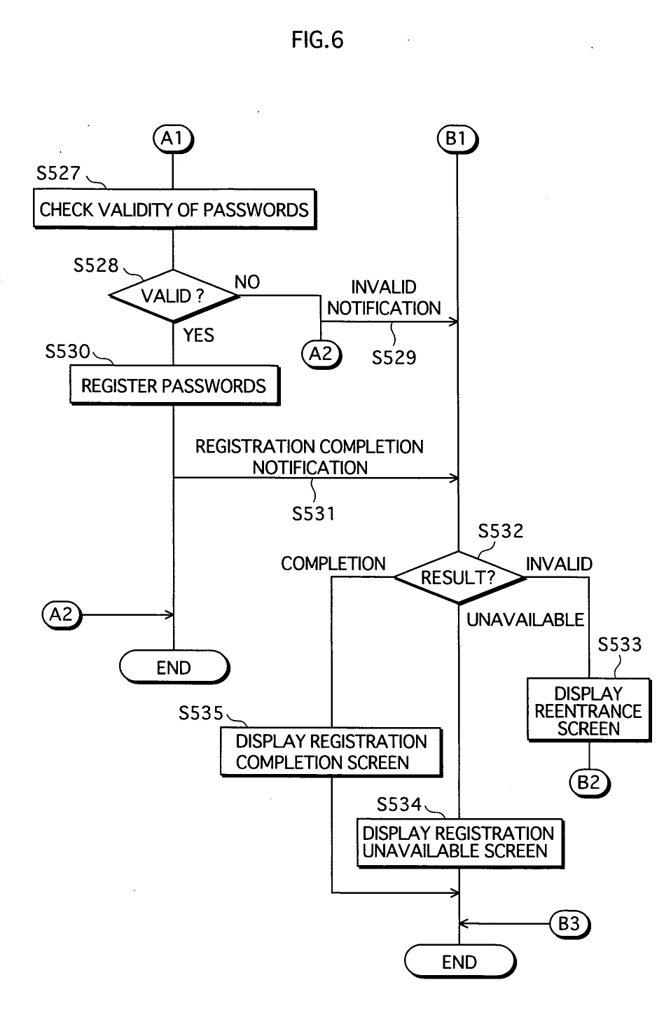

The remote registration of passwords with the server apparatus 100 performed at a client apparatus 200 will be described with reference to FIGS. 5 and 6, which are a flowchart of the procedures.

The input unit 208 of the client apparatus 200 receives a request to register passwords, and outputs the received request to the public key encrypting unit 203 (step S511). The fingerprint authentication unit 207 receives, from the fingerprint input unit 205, a fingerprint which is input by the user (step S512), extracts features of the fingerprint, and reads the features of the user's fingerprint from the fingerprint storage unit 206 (step S513). The fingerprint authentication unit 207 then compares the features to see how much they match, namely at what rate they match, and judges whether the rate of match exceeds a predetermined value (step S514). If the rate of match does not exceed the predetermined value (NO in step S514), which means that the authentication of the user resulted in failure, the fingerprint authentication unit 207 displays on the monitor 251 a screen showing a message that the user cannot use the client apparatus 200 (step S515), and ends the process.

If the rate of match exceeds the predetermined value (YES in step S514), which means that the authentication of the user resulted in success, the fingerprint authentication unit 207 outputs, to the public key encrypting unit 203, permission information indicating that the user is permitted to use the client apparatus 200.

Upon receiving the permission information, the public key encrypting unit 203 performs a mutual authentication with the server apparatus 100 (step S516). When the mutual authentication does not result in success (NO in step S517a), the public key encrypting unit 103 of the server apparatus 100 ends the process. When the mutual authentication results in success (YES in step S517a), the public key encrypting unit 103 continues the process. When the mutual authentication does not result in success (NO in step S517b), the public key encrypting unit 203 of the client apparatus 200 displays a screen notifying the failure of the mutual authentication (step S518), then ends the process. When the mutual authentication results in success (YES in step S517b), the public key encrypting unit 203 outputs the shared key CK, which is generated during the mutual authentication and shared between the server apparatus 100 and the client apparatus 200, to the encrypting unit 211. The input unit 208 receives two passwords for short and long distances (step S519), and outputs the received passwords to the encrypting unit 211.

The encrypting unit 211 generates encrypted passwords by encrypting the passwords using the shared key CK (step S520). The encrypting unit 211 then outputs the generated encrypted passwords to the input/output unit 213. The input/output unit 213 sets the TTL values in the packets to be transmitted, to the standard value n (step S521), and transmits the encrypted passwords packed in the packets to the server apparatus 100 (step S522).

Upon receiving the encrypted passwords from the client apparatus 200 via the input/output unit 113, the distance calculating unit 104 of the server apparatus 100 calculates a difference between the standard value n, which is held by the server apparatus 100 in advance, and the TTL value of the packets received from the client apparatus 200, and outputs the calculated difference value to the public key encrypting unit 103 (step S523). Upon receiving the difference value from the distance calculating unit 104, the public key encrypting unit 103 judges whether the difference value is “0” or not (step S524) When the difference value is not “0” (NO in step S524), the public key encrypting unit 103 transmits, to the client apparatus 200, a notification that the registration is not available (step S525), and ends the process. When the difference value is “0” (YES in step S524), the public key encrypting unit 103 outputs the shared key CK to the decrypting unit 108.

The decrypting unit 108 receives the shared key CK and the encrypted passwords, decrypts the encrypted passwords using the shared key CK, and as a result of this, obtains passwords for short and long distances (step S526), and outputs the passwords to the password checking unit 106.

The password checking unit 106 checks the validity of the passwords in the same manner as steps S502 to S504 (step S527). If it judges that the passwords are invalid (NO in step S528), the password checking unit 106 transmits a notification of this to the client apparatus 200 (step S529). If it judges that the password are valid (YES in step S528), the password checking unit 106 outputs the passwords to the password managing unit 107.

The password managing unit 107 registers the received passwords with the password correspondence table (step S530), transmits a registration completion notification to the client apparatus 200 (step S531), and ends the process.

The public key encrypting unit 203 of the client apparatus 200 analyzes the registration result based on the notification it receives from the server apparatus 100 via the input/output unit 213 (step S532). When it receives the notification that the registration is not available (UNAVAILABLE in step S532), the public key encrypting unit 203 displays on the monitor 251 a screen showing a message that the registration is not available (step S534), and ends the process. When it receives the notification that the passwords are invalid (INVALID in step S532), the public key encrypting unit 203 displays on the monitor 251 the reentrance screen that urges the user to input passwords again (step S533), and returns to step S519. When it receives the registration completion notification (COMPLETION in step S532), the public key encrypting unit 203 displays a registration completion screen on the monitor 251 (step S535), and ends the process.

2.2 Contents Distribution

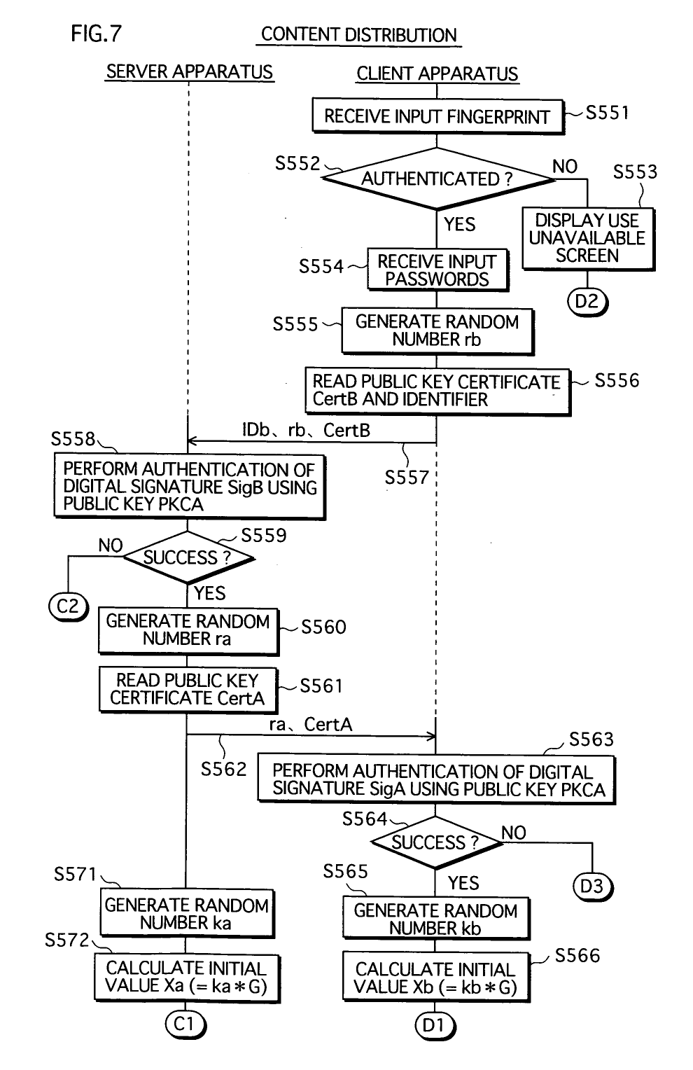

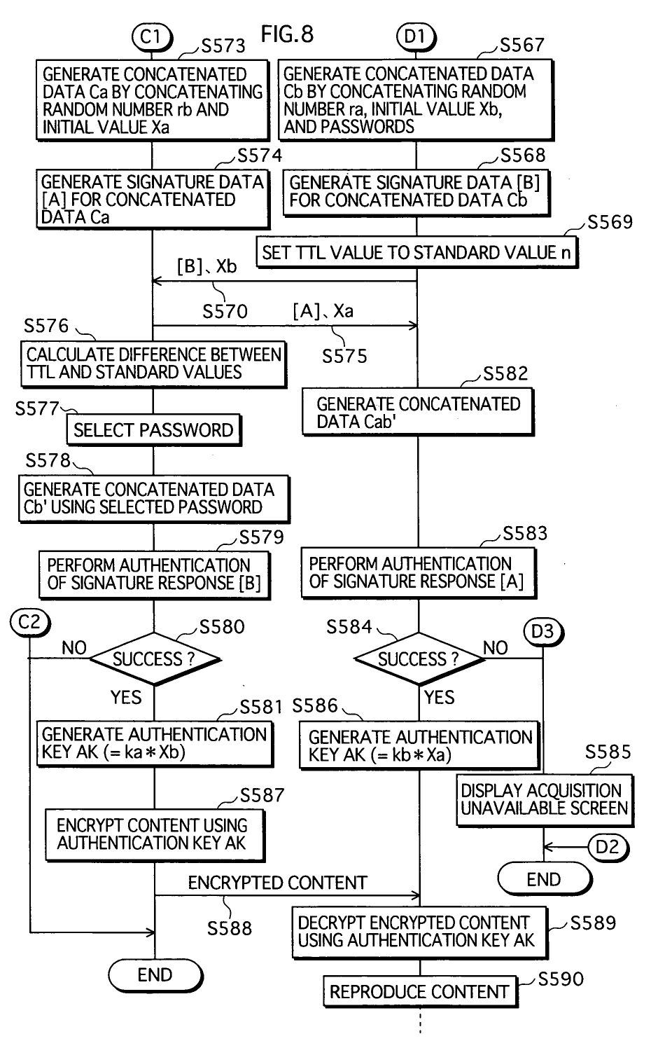

The operation of distributing a content from the server apparatus 100 to the client apparatus 200 will be described with reference to FIGS. 7 and 8.

The client apparatus 200 performs the authentication of an input fingerprint in the same manner as steps 511 to S514 (step S551). If the authentication results in failure (NO in step S552), the client apparatus 200 displays on the monitor 251 a screen showing a message that the user cannot use the client apparatus 200 (step S553), and ends the process. When the authentication results in success (YES in step S552), the client apparatus 200 continues the process. The input unit 208 receives from the user (i) a request to acquire/reproduce a content and (ii) passwords PWb (step S554), and outputs the received data to the public key encrypting unit 203.

Upon receiving the request and the passwords PWb from the input unit 208, the public key encrypting unit 203 performs a mutual authentication with the server apparatus 100, as follows.

The public key encrypting unit 203 generates a random number rb as challenge data (step S555). The public key encrypting unit 203 also reads an identifier IDb from the identifier storage unit 209, and reads the public key certificate CertB from the public key certificate storage unit 202 (step S556). The public key encrypting unit 203 then transmits the read identifier IDb, public key certificate CertB, and random number rb to the server apparatus 100 (step S557).

The public key encrypting unit 103 of the server apparatus 100 receives the identifier IDb, the public key certificate CertB, and the random number rb. The public key encrypting unit 103 also reads the public key PKCA for the CA from the public key certificate storage unit 102. The public key encrypting unit 103 then performs an authentication of the digital signature SigB contained in the received public key certificate CertB, using the read public key PKCA (step S558). When the authentication results in failure (NO in step S559), the public key encrypting unit 103 ends the process. When the authentication results in success (YES in step S559), the public key encrypting unit 103 continues the process. The public key encrypting unit 103 generates a random number ra as challenge data (step S560), reads the public key certificate CertA from the public key certificate storage unit 102 (step S561), then transmits the generated random number ra and the read public key certificate CertA to the client apparatus 200 (step S562).

Upon receiving the random number ra and the public key certificate CertA, the public key encrypting unit 203 of the client apparatus 200 reads the public key PKCA for the CA from the public key certificate storage unit 202, then performs an authentication of the digital signature SigA contained in the received public key certificate CertA, using the read public key PKCA (step S563). When the authentication results in failure (NO in step S564), the public key encrypting unit 203 displays on the monitor 251 a screen showing a message that the registration is not available (step 5585), and ends the process. When the authentication results in success (YES in step S564), the public key encrypting unit 203 continues the process. The public key encrypting unit 203 generates a random number kb (step S565), and calculates an initial value Xb using an equation “initial value Xb=kb*G”, which is based on “EC-DH” being a method for sharing the DH key in the elliptic curve crypto system (step S566). The public key encrypting unit 203 then generates concatenated data Cb by concatenating the random number ra received in step S562, the initial value Xb, and the input passwords PWb in the stated order (step S567). The public key encrypting unit 203 also reads the secret key SKB from the secret key storage unit 201, and generates a signature response [B] corresponding to the concatenated data Cb, using the read secret key SKB (step S568). The TTL value is set to the standard value n (step S569). The generated signature response [B] and the calculated initial value Xb are transmitted to the server apparatus 100 (step S570).

In a similar manner to the client apparatus 200, the public key encrypting unit 103 of the server apparatus 100 generates a random number ka (step S571), and calculates an initial value Xa using an equation “initial value Xa=ka*G” (step S572). The public key encrypting unit 103 then generates concatenated data Ca by concatenating the random number rb received in step S557 and the initial value Xa in the stated order (step S573). The public key encrypting unit 103 also reads the secret key SKA from the secret key storage unit 101, and generates a signature response [A] corresponding to the concatenated data Ca, using the secret key SKA (step S574). The generated signature response [A] and the calculated initial value Xa are transmitted to the client apparatus 200 (step S575).

Upon receiving the generated signature response [B] and the calculated initial value Xb from the client apparatus 200, the distance calculating unit 104 calculates a difference between the standard value n and the TTL value received from the client apparatus 200 (step S576), and outputs the calculated difference value to the public key encrypting unit 103.

The public key encrypting unit 103 determines whether the distance is short or long in accordance with the difference value received from the distance calculating unit 104, and reads a password PWa that corresponds to the determined distance, from the password managing unit 107 (Step S577). The public key encrypting unit 103 then generates concatenated data Cb′ by concatenating the random number ra generated in step S560, the received initial value Xb, and the read password PWa in the stated order (step S578). The public key encrypting unit 103 performs an authentication of the signature response [B] using the generated concatenated data Cb′ and the public key PKB contained in the public key certificate CertB (step S579). When the authentication results in failure (NO in step S580), the public key encrypting unit 103 ends the process. When the authentication results in success (YES in step S580), the public key encrypting unit 103 generates the authentication key AK (=ka*Xb) (step S581).

In a similar manner to the server apparatus 100, upon receiving the generated signature response [A] and the calculated initial value Xa from server apparatus 100, the public key encrypting unit 203 of the client apparatus 200 generates concatenated data Ca′ by concatenating the random number rb generated in step S555 and the received initial value Xa in the stated order (step S582). The public key encrypting unit 203 performs an authentication of the signature response [A] using the generated concatenated data Ca′ and the public key PKA contained in the public key certificate CertA (step S583). When the authentication results in failure (NO in step S584), the public key encrypting unit 203 displays on the monitor 251 a screen showing a message that the content cannot be acquired (step S585), and ends the process. When the authentication results in success (YES in step S584), the public key encrypting unit 103 generates the authentication key AK (=kb*Xa) (step S586).

After the above-described mutual authentication, the authentication key AK is shared by the server apparatus 100 and the client apparatus 200.

The public key encrypting unit 103 of the server apparatus 100 outputs the authentication key AK to the encrypting unit 109. The encrypting unit 109 reads a content from the content storage unit 110, and generates an encrypted content by encrypting the read content using the received authentication key AK (step S587). The public key encrypting unit 103 transmits the generated encrypted content to the client apparatus 200 that requested the content (step S588).

The public key encrypting unit 203 of the client apparatus 200 outputs the shared authentication key AK to the decrypting unit 210. The decrypting unit 210 receives the encrypted content transmitted in step 588 from the server apparatus 103 via the radio communication unit 214 or the input/output unit 213. The decrypting unit 210 decrypts the encrypted content using the authentication key AK, and as a result of this, obtains a content (step S589). The decrypting unit 210 outputs the obtained content to the reproduction unit 212. The reproduction unit 212 receives and reproduces the content (step S590).

3. Variations

The present invention is not limited to the above-described embodiment, but may be varied in many ways. The following provides examples of such variations.

(1) In the above-described embodiment, two different passwords are used in correspondence with the short and long communication distances. However, three or more different passwords may be used instead.

For example, the following three passwords may be used: Password 1 that is short consisting of a small number of characters and is used for a short communication distance corresponding to a value of no greater than “5” as a difference between the standard value n and the TTL value received from the client apparatus; Password 2 that is longer than the Password 1 and is used for a middle distance corresponding to a difference value of “6” to “10”; and Password 3 that is longer than the Password 2 and is used for a long distance corresponding to a difference value of no smaller than “11”. More specifically, for example, Password 1 can be used to improve the convenience of the user in a mutual authentication between client and server apparatuses connected to each other in the home, Password 2 that is longer than Password 1 can be used for a mutual authentication between client and server apparatuses that are connected to each other in the office by a dedicated line via a small number of routers, and Password 3 that is longer than Password 2 and provides higher security can be used in a mutual authentication between client and server apparatuses that are located in different countries with a sea in between and are connected to each other via a great number of routers.

(2) A plurality of passwords may be registered and one of the registered passwords may be used in an authentication. With this arrangement, for example, if the user forgets one of the registered passwords, the user can use another registered password.

Also, a plurality of IDs and passwords may be registered for each client apparatus. Further, a content permitted to be used may be determined for each ID. With this arrangement, for example, members of a family can use different contents, respectively.

Also, a plurality of passwords may be registered for each ID. This arrangement can be applied to a case where a plurality of client apparatuses constitute a group. For example, the server apparatus 100 may be connected to a plurality of client apparatuses in a house, different IDs may be respectively assigned to the plurality of client apparatuses, and the IDs of the client apparatuses may be registered with the server apparatus 100 in correspondence with one password. With such an arrangement, it is possible for a user to use the contents held by the server apparatus 100 at any of the plurality of client apparatuses by inputting the same password.

(3) The password inputting unit 105 of the server apparatus 100 is typically achieved by a keyboard. However, buttons provided in a mobile phone or a remote controller may be used for the data input via the password inputting unit 105, as well. Also, the data input by hands may be replaced by the data input by a card. That is to say, a password may be recorded in an IC card or a secure memory card, and the medium may be inserted into the server apparatus 100 so that the password recorded in the medium is input into the server apparatus 100.

Also, the user may not be required to input a password at each acquisition of contents from the server apparatus 100, but once the user inputs a password, the client apparatus 200 may store the password and use it to acquire contents from the server apparatus thereafter.

(4) In the above-described embodiment, the user is required to input both a password and a fingerprint into a client apparatus 200 for a mutual authentication with the server apparatus. However, the client apparatus 200 may store the password in advance, and only after the user is authenticated by the fingerprint, a mutual authentication between the client apparatus 200 and the server apparatus 100 may be performed using the password.

Also, a characteristic that can be used to identify the user is not limited to the fingerprints, but may be other biometrics information such as the iris, palm print, facial characteristics, voiceprint, handwriting, retina, palm shape, auricle of ear, voice, vein, or DNA that shows a bodily or performance characteristic unique to each living being.

Also, a piece of digital data may be generated based on a piece of biometrics information, such as DNA, that is unique to the user, and the generated piece of digital data may be used as a password when signature data is generated for use in an authentication.

(5) In the above-described embodiment, the public key encrypting unit performs password and apparatus authentications based on the public-key cryptosystem. However, not limited to the public-key cryptosystem, another cryptosystem such as the symmetric-key cryptosystem or the hash function using a key may be used.

(6) In the above-described embodiment, the public key encrypting unit generates concatenated data Cb by concatenating the random number ra, the initial value Xb, and the passwords PWb in the stated order. However, not limited to this, any data may be generated for use in generation of signature data. For example, such data for use in generation of signature data may be generated by concatenating the above-mentioned pieces of data in a different order, or by performing a calculation using these pieces of data.

This also applies to the generation of the concatenated data Ca by the server apparatus 100.

(7) In the above-described embodiment, the server apparatus checks the password of the client apparatus during the authentication process. However, the client apparatus may check the password of the server apparatus, as well.

This can be achieved in the following procedure. When the password of the client apparatus is registered with the server apparatus, the server apparatus sends its own password to the client apparatus. The client apparatus stores the received password of the server apparatus.

Then when the client apparatus attempts to acquire a content from the server apparatus, the server apparatus generates concatenated data Ca in step S573 using the random number rb, the initial value Xa, and the password of the server apparatus 100. The client apparatus 200 generates concatenated data Ca′ in step S582 using the password of the server apparatus 100 stored therein.

This arrangement enables the client apparatus 200 to judge whether the server apparatus on a remote side of the communication is the server apparatus 100 whose password is stored in the client apparatus 200.

(8) The communication distance between the server apparatus 100 and the client apparatus 200 may be measured by PING (Packet INternet Grouper).

The PING method would be applied to the present invention in the following manner. The distance calculating unit 104 of the server apparatus 100 measures the time that elapses after a PING packet is transmitted from the server apparatus 100 to the client apparatus 200 until a response to the PING packet is received by the server apparatus 100. It is possible to determine, based on the measured time, the communication distance between the server apparatus 100 and the client apparatus 200. For example, if the measured time is smaller than a predetermined value, the server apparatus 100 determines that the distance is short. Also, as is the case with the above-described embodiment in which the TTL value is used, the communication distance may be classified into a plurality of levels, and a password may be selected in accordance with the determined distance.

Also, the client apparatus 200 may measure the communication distance between the server apparatus 100 and the client apparatus 200. This can be applied to a case where the client apparatus 200 is connected to a plurality of server apparatuses so that the client apparatus 200 can measure the communication distance for each of the plurality of server apparatuses, and register a password with one among the plurality of server apparatuses that is closest to the client apparatus 200.

(9) In the above-described embodiment, the remote registration of passwords with the server apparatus 100 is available only if the difference between the standard value n and a TTL value received from the client apparatus 200 is “0”. However, the present invention is not limited to this arrangement.

The remote registration of passwords may be available if the difference value is smaller than a predetermined threshold value. Here, the threshold value maybe determined in accordance with the circumstances. For example, the threshold value may be determined differently for two cases: (1) client apparatuses are used in the home; and (2) client apparatuses are used in the office.

(10) In the above-described embodiment, the server apparatus 100 transmits, after the mutual authentication results in success, an encrypted content that is generated by encrypting a content using the shared key CK. However, the present invention is not limited to this, but may take another means in so far as the server apparatus can safely transmit the contents to the client apparatuses. For example, the server apparatus 100 may transmit to the client apparatus 200: (i) an encrypted content that is generated by encrypting a content using a content key; and (ii) an encrypted content key that is generated by encrypting the content key using the shared key CK. After receiving these data, the client apparatus 200 first obtains the content key in the original form by decrypting the encrypted content key using the shared key CK, and obtains the content in the original form by decrypting the encrypted content using the obtained content key.

Also, the server apparatus 100 may store in advance encrypted contents, or obtain encrypted contents from another recording medium or apparatus.

(11) In the above-described embodiment, passwords are permitted to be registered only if they meet certain conditions. However, the conditions may be varied. For example, each password may include a numeral, or may include a word that is contained in a dictionary. Also, different sets of conditions may be set in correspondence with different ranges of communication distances. For example, it may be set that passwords to be registered from distant client apparatuses should meet a greater number of conditions than those from closer client apparatuses. Also, a range of the number of characters may be specified as a condition instead of the number of characters. For example, each password may be required to contain “no less than 5 characters” or “no more than 10 characters”.

(12) The present invention may be achieved as (i) a method for use in the above-described apparatus authentication system, (ii) a computer program that causes a computer to achieve the method, or (iii) digital signals representing the computer program.

Also, the present invention may be achieved as a computer-readable recording medium, such as a flexible disk, a hard disk, a CD-ROM, an MO, a DVD, a DVD-ROM, a DVD-RAM, a BD (Blu-Ray Disc), or a semiconductor memory, in which the above-mentioned computer program or the digital signals are recorded. Also, the present invention may be achieved as the computer program or the digital signals recorded in such a recording medium.

The computer program or the digital signals as the present invention may be transferred via an electric communication line, a radio or wired communication line, or a network as represented by the Internet.

Also, the present invention may be achieved as a computer system including a microprocessor and a memory, where the memory stores a computer program, and the microprocessor operates in accordance with the computer program.

The computer program or the digital signals as the present invention may be transferred to an independent computer system via any of the above-described recording mediums or via the Internet or the like, and may be executed at the independent computer system.

(13) The present invention may be achieved as any combination of the above-described embodiment and variations.

4. Summary

As described earlier, the object of the present invention is fulfilled by an apparatus authentication system which comprises a server apparatus and a client apparatus which perform a mutual authentication when a content is transmitted from the server apparatus to the client apparatus for use therein, wherein the client apparatus includes: a receiving unit operable to receive challenge data from the server apparatus; a signature generating unit operable to generate signature data based on the received challenge data and a first password; and a transmitting unit operable to transmit the generated signature data, and the server apparatus includes: a challenge data transmitting unit operable to generate and transmit challenge data; a holding unit operable to hold a second password in advance; a receiving unit operable to receive the signature data from the client apparatus; an authentication unit operable to perform an authentication of the received signature data based on the challenge data and the second password; and a content transmitting unit operable to, if the authentication results in success, transmit an encrypted content to the client apparatus, the encrypted content having been encrypted in such a manner that the encrypted content can be decrypted by the client apparatus.

The object of the present invention is also fulfilled by a server apparatus for transmitting a content to a client apparatus, comprising: a holding unit operable to hold a registered password; a challenge data transmitting unit operable to generate and transmit challenge data; a receiving unit operable to receive, from the client apparatus, signature data that has been generated based on a password and the challenge data; an authentication unit operable to perform an authentication of the received signature data based on the registered password and the challenge data; and a content transmitting unit operable to, if the authentication results in success, transmit an encrypted content to the client apparatus, the encrypted content having been encrypted in such a manner that the encrypted content can be decrypted by the client apparatus.

The object of the present invention is also fulfilled by a client apparatus for receiving a content from a server apparatus and reproducing the received content, comprising: a receiving unit operable to receive challenge data from the server apparatus; a signature generating unit operable to generate signature data based on the received challenge data and a first password; a transmitting unit operable to transmit the generated signature data to the server apparatus; and a content receiving unit operable to, if an authentication of the signature data results in success in the server apparatus, receive an encrypted content from the server apparatus, the encrypted content having been encrypted in such a manner that the encrypted content can be decrypted by the client apparatus.

The above-described construction enables the server apparatus, while in communication with a client apparatus, to perform an authentication of the client apparatus, using a password that has been registered with the server apparatus. That is to say, success in the authentication certifies that the client apparatus has registered the password with the server apparatus. This enables the server apparatus to determine whether the client apparatus is authorized to use contents, as well as to confirm the authenticity of the client apparatus.

An apparatus using a conventional technique based on DTCP and WEP needs to perform authentications respectively to confirm the authenticity of a target apparatus, and to determine whether the target apparatus is authorized to connect with the apparatus that performs the authentications. This requires a lot of transactions. In contrast, the present invention enables an apparatus to perform both types of authentications with less transactions. Also, DTCP encrypts contents in the application layer, and WEP encrypts contents in the MAC layer. Performing such double encryption wastes time and effort, and applies heavy loads to both the server and client apparatuses. In contrast, the present invention applies less loads since the encryption is performed only once.

The above-stated server apparatus may further comprises a registering unit operable to register a password, which is input from outside the server apparatus, with the holding unit as the registered password.

With the above-described construction, an authorized user of the client apparatus can input a password directly into the server apparatus to register the password with the server apparatus. This prevents unauthorized registration of a password by anyone other than the authorized user.

The above-stated server apparatus may further comprise: a distance judging unit operable to detect a communication distance between the server apparatus and the client apparatus, and judge whether the detected communication distance is within a predetermined range of values; and a registering unit operable to, if the distance judging unit judges that the detected communication distance is within the predetermined range of values, register a password, which is transmitted from the client apparatus, with the holding unit as the registered password.

The above-stated server apparatus may further comprise: a password receiving unit operable to receive a password which is input from outside, wherein the transmitting unit transmits the received password to the server apparatus, and the server apparatus receives and stores the password as a registered password.

Here, the server apparatus may judge whether input data is valid as a password to be registered, based on a communication distance between the server and client apparatuses. This prevents unauthorized registration of passwords.

In the above-stated server apparatus, the holding unit may hold a first password and a second password that has a greater number of characters than the first password, and the authentication unit includes: a distance detecting sub-unit operable to detect a communication distance between the server apparatus and the client apparatus; a password selecting sub-unit operable to select the first password if the detected communication distance is shorter than a predetermined communication distance, and select the second password if the detected communication distance is not shorter than the predetermined communication distance; and an authentication sub-unit operable to perform the authentication of the received signature data based on the challenge data and the selected password as the registered password.

With the above-described construction in which a short or a long password is selected depending on the detected communication distance, enabling the passwords to be used according to the circumstances. For example, a password composed of a small number of characters may be used to improve the convenience of the user when the communication distance is short, and, for example, both server and client apparatuses are used in the home. This is because there is less fear that the apparatuses come under attacks such as a tapping and a disguise. On the contrary, a password composed of a great number of characters may be used to improve the safety when the communication distance is long, which may be in such a case where the server apparatus is connected with the client apparatus via the Internet.

The above-stated client apparatus may further comprise a distance detecting unit operable to detect a communication distance between the client apparatus and the server apparatus, wherein the transmitting unit transmits the received password to the server apparatus if the detected communication distance is shorter than a predetermined communication distance.

With the above-described construction, the client apparatus determines whether a server apparatus is located near the client apparatus based on the detected communication distance. This enables the client apparatus to register passwords with a server apparatus that is located near the client apparatus.

In the above-stated client apparatus, a password of the client apparatus has been registered with a server apparatus in advance, the transmitting unit generates and transmits authentication challenge data to the server apparatus before the content receiving unit receives the encrypted content from the server apparatus, the content receiving unit receives, before receiving the encrypted content, server signature data that is generated by the server apparatus based on the transmitted authentication challenge data and a first server password held by the server apparatus, the client apparatus further comprising: a password holding unit operable to acquire a second server password from the server apparatus with which the password of the client apparatus has been registered, and hold the acquired second server password; and an authentication unit operable to perform an authentication of the received server signature data based on the authentication challenge data and the second server password, wherein the content receiving unit receives the encrypted content from the server apparatus if the authentication of the server signature data results in success.

With the above-described construction, the client apparatus stores, in advance, a server password of a server apparatus with which the password of the client apparatus has been registered. The client apparatus then performs an authentication using the server password when attempting to acquire a content from a server apparatus. This enables the client apparatus to determine whether a server apparatus currently in communication with the client apparatus is the server apparatus with which the password of the client apparatus has been registered, as well as to check the authenticity of the server apparatus.

The above-stated client apparatus may further comprise a user authentication unit which includes: a storage sub-unit operable to store, in advance, first authentication data which is generated by extracting features of first unique information that is a characteristic an authorized user has uniquely as a living being; an information receiving sub-unit operable to receive second unique information input by a user, the second unique information being a characteristic unique to the user as a living being; a feature extracting sub-unit operable to generate second authentication data by extracting features of the second unique information; and a judging sub-unit operable to judge whether a rate of match between the first authentication data and the second authentication data exceeds a predetermined value, wherein the signature generating unit generates the signature data if the user authentication unit judges that the rate of match exceeds the predetermined value.

With the above-described construction, the client apparatus judges whether a user is authorized to use the client apparatus, using information unique to an authorized user. This enables unauthorized person to be prevented from using the client apparatus. That is to say, this prevents unauthorized use of contents.

The object of the present invention is also fulfilled by an apparatus authentication system which comprises a server apparatus and a client apparatus which perform a mutual authentication when a content is transmitted from the server apparatus to the client apparatus for use therein, wherein the client apparatus includes: a receiving unit operable to receive challenge data from the server apparatus; a signature generating unit operable to generate signature data based on the received challenge data and authentication data which is generated based on a characteristic of a user of the client apparatus that the user has uniquely as a living being; and a transmitting unit operable to transmit the generated signature data, and the server apparatus includes: a challenge data transmitting unit operable to generate and transmit challenge data; a holding unit operable to hold, in advance, registered data which is generated based on a characteristic that an authorized user, who is authorized to use contents, has uniquely as a living being; a receiving unit operable to receive the signature data from the client apparatus; an authentication unit operable to perform an authentication of the received signature data based on the challenge data and the registered data; and a content transmitting unit operable to, if the authentication results in success, transmit an encrypted content to the client apparatus, the encrypted content having been encrypted in such a manner that the encrypted content can be decrypted by the client apparatus.

With the above-described construction, the authentication of a user is performed making use of a characteristic an authorized user uniquely has as a living being. This prevents an unauthorized user from disguising the authorized user, thus preventing unauthorized use of the client apparatus. This also relieves users of inputting data such as a password, thus relieving the users of memorizing the password or the like. As a result, this saves the users time and effort required for the authentication.

The holding unit of the server apparatus may hold a plurality of registered passwords.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An apparatus authentication system which comprises a server apparatus and a client apparatus which perform a mutual authentication when a content is transmitted from the server apparatus to the client apparatus for use therein, wherein the client apparatus includes:
a receiving unit operable to receive challenge data from the server apparatus;
a signature generating unit operable to generate signature data based on the received challenge data and a first password; and
a transmitting unit operable to transmit the generated signature data, and
the server apparatus includes:
a challenge data transmitting unit operable to generate and transmit the challenge data;
a holding unit operable to hold a second password in advance;
a receiving unit operable to receive the signature data from the client apparatus;
an authentication unit operable to perform an authentication of the received signature data based on the challenge data and the second password; and
a content transmitting unit operable to, if the authentication results in success, transmit an encrypted content to the client apparatus, the encrypted content having been encrypted in such a manner that the encrypted content can be decrypted by the client apparatus.

2. A server apparatus for transmitting a content to a client apparatus, comprising:
a holding unit operable to hold a registered password;
a challenge data transmitting unit operable to generate and transmit challenge data;
a receiving unit operable to receive, from the client apparatus, signature data that has been generated based on a password and the challenge data;
an authentication unit operable to perform an authentication of the received signature data based on the registered password and the challenge data; and
a content transmitting unit operable to, if the authentication results in success, transmit an encrypted content to the client apparatus, the encrypted content having been encrypted in such a manner that the encrypted content can be decrypted by the client apparatus.

3. The server apparatus of claim 2 further comprising
a registering unit operable to register a password, which is input from outside the server apparatus, with the holding unit as the registered password.

4. The server apparatus of claim 2 further comprising:
a distance judging unit operable to detect a communication distance between the server apparatus and the client apparatus, and judge whether the detected communication distance is within a predetermined range of values; and
a registering unit operable to, if the distance judging unit judges that the detected communication distance is within the predetermined range of values, register a password, which is transmitted from the client apparatus, with the holding unit as the registered password.

5. The server apparatus of claim 2, wherein
the holding unit holds a first password and a second password that has a greater number of characters than the first password, and
the authentication unit includes:
a distance detecting sub-unit operable to detect a communication distance between the server apparatus and the client apparatus;
a password selecting sub-unit operable to select the first password if the detected communication distance is shorter than a predetermined communication distance, and select the second password if the detected communication distance is not shorter than the predetermined communication distance; and
an authentication sub-unit operable to perform the authentication of the received signature data based on the challenge data and the selected password as the registered password.

6. A client apparatus for receiving a content from a server apparatus and reproducing the received content, comprising:
a receiving unit operable to receive challenge data from the server apparatus;
a signature generating unit operable to generate signature data based on the received challenge data and a first password;
a transmitting unit operable to transmit the generated signature data to the server apparatus; and
a content receiving unit operable to, if an authentication of the signature data results in success in the server apparatus, receive an encrypted content from the server apparatus, the encrypted content having been encrypted in such a manner that the encrypted content can be decrypted by the client apparatus.

7. The client apparatus of claim 6 further comprising
a password receiving unit operable to receive a password which is input from outside, wherein
the transmitting unit transmits the received password to the server apparatus, and
the server apparatus receives and stores the password as a registered password.

8. The client apparatus of claim 7 further comprising
a distance detecting unit operable to detect a communication distance between the client apparatus and the server apparatus, wherein
the transmitting unit transmits the received password to the server apparatus if the detected communication distance is shorter than a predetermined communication distance.

9. The client apparatus of claim 6, wherein
a password of the client apparatus has been registered with a server apparatus in advance,
the transmitting unit generates and transmits authentication challenge data to the server apparatus before the content receiving unit receives the encrypted content from the server apparatus,
the content receiving unit receives, before receiving the encrypted content, server signature data that is generated by the server apparatus based on the transmitted authentication challenge data and a first server password held by the server apparatus,
the client apparatus further comprising:
a password holding unit operable to acquire a second server password from the server apparatus with which the password of the client apparatus has been registered, and hold the acquired second server password; and
an authentication unit operable to perform an authentication of the received server signature data based on the authentication challenge data and the second server password, wherein
the content receiving unit receives the encrypted content from the server apparatus if the authentication of the server signature data results in success.

10. The client apparatus of claim 6 further comprising a user authentication unit which includes:
a storage sub-unit operable to store, in advance, first authentication data which is generated by extracting features of first unique information that is a characteristic an authorized user has uniquely as a living being;
an information receiving sub-unit operable to receive second unique information input by a user, the second unique information being a characteristic unique to the user as a living being;
a feature extracting sub-unit operable to generate second authentication data by extracting features of the second unique information; and
a judging sub-unit operable to judge whether a rate of match between the first authentication data and the second authentication data exceeds a predetermined value, wherein the signature generating unit generates the signature data if the user authentication unit judges that the rate of match exceeds the predetermined value.

11. An apparatus authentication system which comprises a server apparatus and a client apparatus which perform a mutual authentication when a content is transmitted from the server apparatus to the client apparatus for use therein, wherein
the client apparatus includes:
a receiving unit operable to receive challenge data from the server apparatus;
a signature generating unit operable to generate signature data based on the received challenge data and authentication data which is generated based on a characteristic of a user of the client apparatus that the user has uniquely as a living being; and
a transmitting unit operable to transmit the generated signature data, and
the server apparatus includes:
a challenge data transmitting unit operable to generate and transmit the challenge data;
a holding unit operable to hold, in advance, registered data which is generated based on a characteristic that an authorized user, who is authorized to use contents, has uniquely as a living being;
a receiving unit operable to receive the signature data from the client apparatus;
an authentication unit operable to perform an authentication of the received signature data based on the challenge data and the registered data; and
a content transmitting unit operable to, if the authentication results in success, transmit an encrypted content to the client apparatus, the encrypted content having been encrypted in such a manner that the encrypted content can be decrypted by the client apparatus.

12. A method for use in a server apparatus that transmits a content to a client apparatus, wherein
the server apparatus holds a registered password,
the method comprising:
a challenge data transmitting step for generating and transmitting challenge data;
a receiving step for receiving, from the client apparatus, signature data generated based on a password and the challenge data;
an authentication step for performing an authentication of the received signature data based on the registered password and the challenge data; and
a content transmitting step for, if the authentication results in success, transmitting an encrypted content to the client apparatus, the encrypted content having been encrypted in such a manner that the encrypted content can be decrypted by the client apparatus.

13. A program for use in a server apparatus that transmits a content to a client apparatus, wherein
the server apparatus holds a registered password,
the program comprising:
a challenge data transmitting step for generating and transmitting challenge data;
a receiving step for receiving, from the client apparatus, signature data generated based on a password and the challenge data;
an authentication step for performing an authentication of the received signature data based on the registered password and the challenge data; and
a content transmitting step for, if the authentication results in success, transmitting an encrypted content to the client apparatus, the encrypted content having been encrypted in such a manner that the encrypted content can be decrypted by the client apparatus.

14. A computer-readable recording medium which records therein a program for use in a server apparatus that transmits a content to a client apparatus, wherein
the server apparatus holds a registered password,
the program comprising:
a challenge data transmitting step for generating and transmitting challenge data;
a receiving step for receiving, from the client apparatus, signature data generated based on a password and the challenge data;
an authentication step for performing an authentication of the received signature data based on the registered password and the challenge data; and
a content transmitting step for, if the authentication results in success, transmitting an encrypted content to the client apparatus, the encrypted content having been encrypted in such a manner that the encrypted content can be decrypted by the client apparatus.

15. A method for use in a client apparatus that receives a content from a server apparatus and reproduces the received content, the method comprising:
a receiving step for receiving challenge data from the server apparatus;
a signature generating step for generating signature data based on the received challenge data and a password;
a transmitting step for transmitting the generated signature data to the server apparatus; and
a content receiving step for, if an authentication of the signature data results in success in the server apparatus, receiving an encrypted content from the server apparatus, the encrypted content having been encrypted in such a manner that the encrypted content can be decrypted by the client apparatus.

16. A program for use in a client apparatus that receives a content from a server apparatus and reproduces the received content, the program comprising:
a receiving step for receiving challenge data from the server apparatus;
a signature generating step for generating signature data based on the received challenge data and a password;
a transmitting step for transmitting the generated signature data to the server apparatus; and
a content receiving step for, if an authentication of the signature data results in success in the server apparatus, receiving an encrypted content from the server apparatus, the encrypted content having been encrypted in such a manner that the encrypted content can be decrypted by the client apparatus.

17. A computer-readable recording medium which records therein a program for use in a client apparatus that receives a content from a server apparatus and reproduces the received content, the program comprising:
a receiving step for receiving challenge data from the server apparatus;
a signature generating step for generating signature data based on the received challenge data and a password;
a transmitting step for transmitting the generated signature data to the server apparatus; and
a content receiving step for, if an authentication of the signature data results in success in the server apparatus, receiving an encrypted content from the server apparatus, the encrypted content having been encrypted in such a manner that the encrypted content can be decrypted by the client apparatus.
